(19) United States
(12) Patent Application Publication
(10) Pub. No.: US 2026/0227004 A1
(43) Pub. Date: Aug. 6, 2026

(54) PIPE REPLACEMENT DRUM DEVICE AND METHOD

(71) Applicant: TT Technologies, Inc., Aurora, IL (US)

(72) Inventor: John A. Olander, Clayton, WI (US)

(21) Appl. No.: 19/462,187

(22) Filed: Jan. 28, 2026

Related U.S. Application Data
(60) Provisional application No. 63/752,321, filed on Jan. 31, 2025.

(51) Int. Cl. F16L 1/028; B66D 3/20; F16L 55/18

(52) U.S. Cl. CPC F16L 1/028; B66D 3/20; F16L 55/18

(57) ABSTRACT

A pipe replacement device, components of a pipe replacement device and associated methods are disclosed. Examples are shown that include multiple optional pulling orientations. Examples are shown that include a splitter that loads laterally over a cable. Examples are shown that include an arced reaction plate to provide boom adjustability. Examples are shown that include a retaining plate for optional pipe bursting. Examples are shown that include a removable portion of a winch drum for ease of disposal of pulled pipe.

### CLAIM OF PRIORITY

This patent application claims the benefit of priority, under 35 U.S.C. § 119(e), to U.S. Provisional Patent Application Serial No. 63/752,321, entitled “PIPE REPLACEMENT DRUM DEVICE AND METHOD,” filed on Jan 31, 2025, which is hereby incorporated by reference herein in its entirety.

### TECHNICAL FIELD

Embodiments described herein generally relate to underground pipe bursting and pipe replacement tools and associated methods.

### BACKGROUND

The replacement of aging and potentially hazardous piping systems is a significant concern in modern infrastructure maintenance. Over time, various types of pipes, such as lead, cast iron, steel, and older plastic materials, can degrade, fail to meet contemporary safety standards, or pose risks to public health and the environment. For example, lead pipes, once widely used for their durability and malleability, have been a focus of replacement efforts due to the well-documented health risks associated with lead exposure.

Pipe degradation can result in multiple issues, including contamination of water supplies, reduced flow efficiency, leaks, and structural instability. The specific risks depend on the material and condition of the pipe. For instance, corroded steel or iron pipes can introduce rust and sediment into water systems, while aging plastic pipes may release harmful chemicals or develop micro-cracks that compromise their functionality.

Replacement initiatives for old or unsafe pipes typically aim to address these challenges by upgrading systems with modern materials like copper, PVC, or cross-linked polyethylene (PEX). However, these projects are often complex and costly.

Technological advancements have led to more efficient and less invasive pipe replacement methods. Trenchless techniques, such as pipe bursting, sliplining, and cured-in-place pipe (CIPP) lining, have gained popularity for their ability to replace or rehabilitate pipes with minimal surface disruption. Despite these innovations, large-scale pipe replacement projects remain logistically and financially challenging.

Improved methods and tools to streamline the replacement process, reduce associated costs, and ensure the long-term safety and reliability of water and other piping systems are desired. Pipe replacement devices and methods described in the present disclosure address these, and other technical challenges.

### BRIEF DESCRIPTION OF THE DRAWINGS

FIG. 1 shows a pipe replacement device in accordance with some example embodiments.

FIG. 2A shows a side view of a pipe replacement device in operation in accordance with some example embodiments.

FIG. 2B shows another side view of a pipe replacement device in operation in accordance with some example embodiments.

FIG. 3A shows aside view of a pipe replacement device in accordance with some example embodiments.

FIG. 3B shows an isometric view of the pipe replacement device from FIG. 3A in accordance with some example embodiments.

FIG. 3C shows a side view of a pipe replacement device in operation in accordance with some example embodiments.

FIG. 4A shows an isometric view of a pipe splitting fixture in accordance with some example embodiments.

FIG. 4B shows an isometric view of selected components of a pipe splitting fixture in accordance with some example embodiments.

FIG. 4C shows another isometric view of selected components of a pipe splitting fixture in accordance with some example embodiments.

FIG. 5A shows an isometric view of selected components of a pipe splitting fixture in accordance with some example embodiments.

FIG. 5B shows an isometric view of selected components of a pipe splitting fixture in accordance with some example embodiments.

FIG. 5C shows an isometric view of selected components of a pipe splitting fixture in accordance with some example embodiments.

FIG. 6 shows an isometric view of selected components of a pipe splitting fixture in accordance with some example embodiments.

FIG. 7 shows a side view of a pipe replacement device in operation in accordance with some example embodiments.

FIG. 8 shows another side view of a pipe replacement device in operation in accordance with some example embodiments.

FIG. 9 shows an exploded view of a pipe replacement device in operation in accordance with some example embodiments.

FIG. 10 shows an isometric view of selected components of a pipe replacement device in operation in accordance with some example embodiments.

FIG. 11 shows an example method diagram for operation of a pipe replacement device in accordance with some example embodiments.

FIG. 12 shows another example method diagram for operation of a pipe replacement device in accordance with some example embodiments.

FIG. 13 shows another example method diagram for operation of a pipe replacement device in accordance with some example embodiments.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

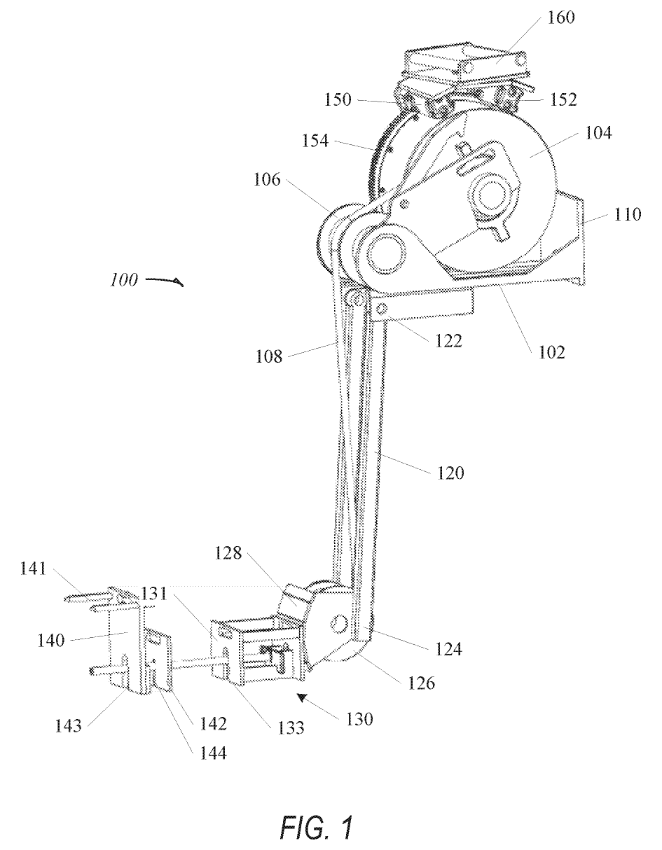

FIG. 1 shows a pipe replacement device 100 according to one example. Although the device 100 is particularly useful for pipe replacement, it can also be used to pull a cable with a bursting tool through the ground to burst a pipe and leave the burst pipe in the ground with a replacement pipe pulled into the space previously occupied by the burst pipe. However, the following disclosure focuses on the example of pipe removal in many instances to simplify discussion of attributes of the device 100.

The pipe replacement device 100 includes a device frame 102. A winch drum 104 is shown coupled to a pair of driving motors 150, 152. Although a pair of motors are shown in the example of FIG. 1, the invention is not so limited. A single driving motor, or more that two motors are also within the scope of the present disclosure. Examples of driving motors 150, 152 include, but are not limited to, hydraulic motors, electric motors, etc. In the example shown, the driving motors 150, 152 engage teeth 154 located on a rim of the winch drum 104. Although teeth 154 are shown engaging corresponding teeth on drive gears of driving motors 150, 152, the invention is not so limited. Other drive configurations, such as a chain drive, belt drive, etc. are within the scope of the invention.

A mount 160 is shown coupled to the pipe replacement device 100 in FIG. 1. In one example, the mount 160 is adapted to attach to an arm of a ground working vehicle. An example of a ground working vehicle includes a backhoe arm. Although a backhoe is used as an example, the invention is not so limited. Other ground working vehicles include landscaping vehicles, skid steer vehicles, cranes, etc. The pipe replacement device 100 is made from metal, and may be heavy for a user to carry to a pit for a pipe extraction or bursting operation. The ability to move the pipe replacement device 100 using a ground working vehicle eases a burden on the user.

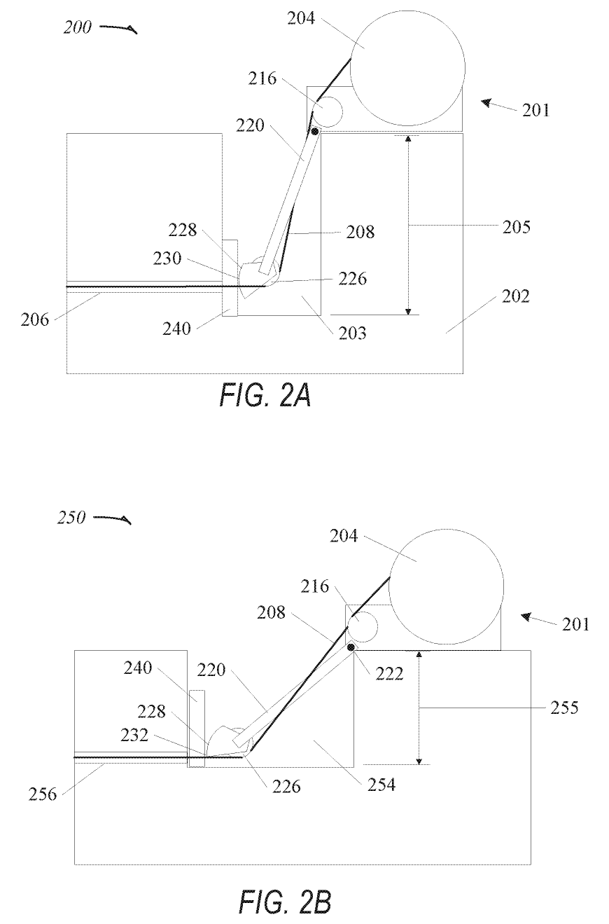

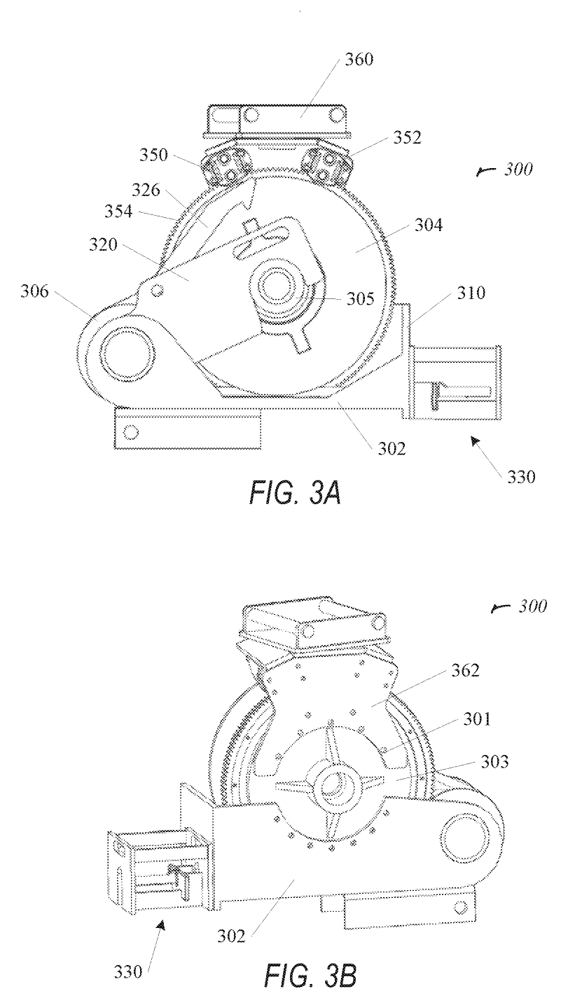

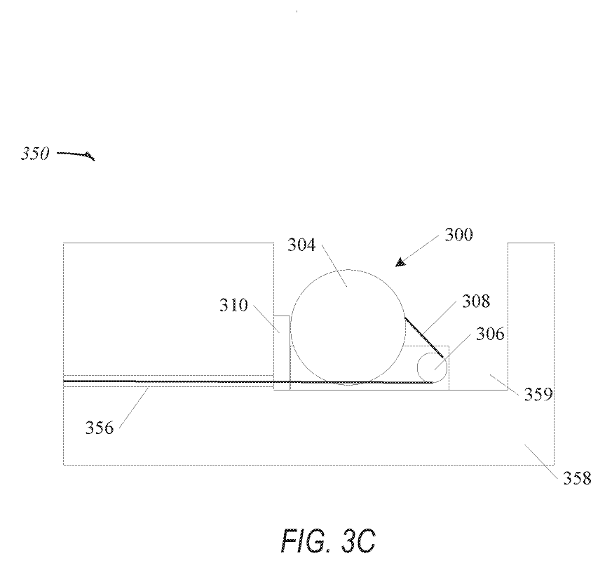

A first reaction plate 110 is shown coupled to the device frame 102. The first reaction plate 110 defines a first in-line pipe pulling orientation. A boom 120 is further shown coupled to the device frame 102, the boom 120 defines a second, optional pulling orientation, different from the first in-line pipe pulling orientation. In the example of FIG. 1, a cable 108 is shown extending from the winch drum 104, over a guide pulley 106 and adjacent to the boom 120. In the configuration of FIG. 1, the cable is being utilized in the second pulling orientation, and is not utilizing the first reaction plate 110. FIGS. 2A-2B show further illustrations of the second pulling orientation utilizing the boom 120. The first in-line pipe pulling orientation is shown in more detail in FIGS. 3A-3C .

In one example, the location of the guide pulley 106 provides a reduction or elimination of unwanted counter rotation of the frame 702 during a pulling operation. The guide pulley 106 contains any rotation force to within the winch drum 104 and frame 102 assembly and allows the pipe replacement device 100 to apply a liner force along the cable direction. As such, the pipe replacement device 100 can be set without being attached to an excavator and still be stable. In contrast, if pulling directly from the winch drum 104 the frame 102 would want to counter rotate relative to the winch drum 104.

The boom 120 is shown coupled to the frame 102 at a proximal end by a hinge 122 that facilitates folding the boom 120 underneath the frame 102 when not in use. FIG. 1 further shows components at a distal end 124 of the boom 120. A distal pulley 126 is included at the distal end 124, and a second reaction plate 128. In the example of FIG. 1, the second reaction plate 128 is arced, to facilitate different angles of contact with a side of a pit, or intervening structures located within a pit. This is discussed in more detail in FIGS. 2A an 2B below.

A pipe splitting fixture 130 is shown in FIG. 1 located adjacent to the second reaction plate 128. A soil stake plate 140 is shown spaced apart from the pipe splitting fixture 130. A number of soil stakes 141 are shown, that may be used to hold the soil stake plate 140 in place directly against soil in a side of a pit. A vertical slot 143 is included in the soil stake plate 140 to facilitate side loading of the soil stake plate 140 onto the cable 108. In operation, it is advantageous to be able to assemble components, such as the soil stake plate 140, onto the cable 108 laterally, or over a side surface of the cable 108. This allows the cable 108 to be threaded through the pipe to be replaced first, without having to be concerned with which components were threaded through the cable 108 before the cable 108 is threaded through the pipe to be replaced. Operating in a pit is often messy and cramped. It is desirable to be able to assemble components for pipe removal or pipe bursting at different times in an operation by lateral insertion over the cable 108. Lateral insertion of various components also provides an option to switch or add different components without having to withdraw the cable 108 from the pipe to be replaced. For example, an end plate 131 of the splitting fixture 130 includes a vertical slot 133, and an optional retaining plate 142 includes another vertical slot 144.

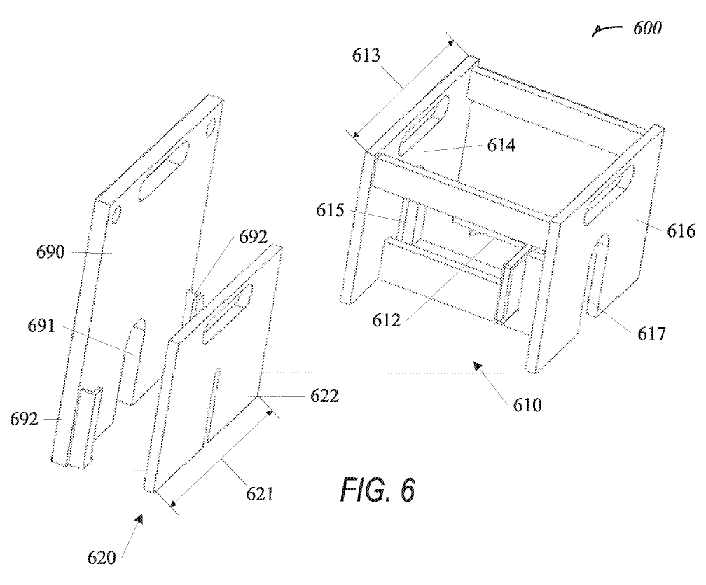

The retaining plate 142 is shown adjacent to the soil stake plate 140. In the example shown, the retaining plate 142 includes a same or similar dimension with the end plate 131 of the splitting fixture 130. The retaining plate 142 can be used alternatively to the splitting fixture 130 for different types of pipe extraction, and the same or similar dimension facilities switching between the retaining plate 142 and the splitting fixture 130. In one example, the same or similar dimension incudes a plate width and/or a plate thickness that mates with a slot in the soil stake plate 140. This feature is discussed in more detail with respect to FIG. 6.

FIGS. 2A and 2B show examples of a pipe replacement device 201 in operation. FIG. 2A shows a first replacement operation 200. A first pit 203 in a ground region 202 is shown, exposing a first pipe to be replaced 206. The first pit 203 has a first depth 205. The pipe replacement device 201 is configured to align with the first pipe to be replaced 206 and accommodate the first depth 205 of the first pit 203.

A winch drum 204 is coupled to a cable 208. The cable 208 extends over a guide pulley 216 at a proximal end of a boom 220, and down to a distal pulley 226 at a distal end of the boom 220. The cable 208 then passes through the first pipe to be replaced 206 and is coupled to a splitting or bursting tool (not shown) at a distal end of the pipe to be replaced 206. A reaction plate 228 is coupled adjacent to the distal pulley 226 at the distal end of the boom 220. In the example of FIG. 2A, the reaction plate 228 abuts a plate 240 that is positioned between the reaction plate 228 and a side of the first pit 203. Because the reaction plate 228 includes an arced surface, the reaction plate 228 contacts the plate 240 at a tangent 230 of the reaction plate 228. The arced surface of the reaction plate 228 provides the ability to operate the pipe replacement device 201 with the boom 220 at a number of different angles to accommodate different pit depths.

FIG. 2B shows the pipe replacement device 201 in operation with a second pit 254 having a second depth 255 that is shallower than the first depth 205 of the first pit 203 in FIG. 2A. FIG. 2B shows a second replacement operation 250. As shown in FIG. 2B, the boom 220 is able to rotate at hinge 222 to adjust for the shallower second depth 255 of the second pit 254. The cable 208 is shown extending over the guide pulley 216 at a proximal end of a boom 220, and down to a distal pulley 226 at a distal end of the boom 220. The cable 208 then passes through the second pipe to be replaced 256 and is coupled to a splitting or bursting tool (not shown) at a distal end of the second pipe to be replaced 256.

Because the reaction plate 228 includes an arced surface, the reaction plate 228 contacts the plate 240 at a tangent of the reaction plate 228. The tangent 232 of FIG. 2B is different than the tangent 230 of FIG. 2A because of the different depths 205, 255 of the pits 203, 254. An angle of the boom 220 accommodates the differences in depth 205, 255, and the arced reaction plate 228 is able to provide a desired reaction force against the plate 240 by contacting at different tangents 230, 232.

FIGS. 3A-3C show examples of a pipe replacement device 300 similar to pipe replacement devices discussed above. The pipe replacement device 300 is shown operating in a configuration for placement of the device 300 within a pit, not using a boom.

The pipe replacement device 300 in FIG. 3A includes a device frame 302. A winch drum 304 is shown coupled to a pair of driving motors 350, 352. In the example shown, the driving motors 350, 352 engage teeth 354 located on a rim of the winch drum 304.

A mount 360 is shown coupled to the pipe replacement device 300 in FIG. 3A. In one example, the mount 360 is adapted to attach to an arm of a ground working vehicle. As discussed above, examples of a ground working vehicle include a backhoe arm. Although a backhoe is used as an example, the invention is not so limited. Other ground working vehicles include landscaping vehicles, skid steer vehicles, cranes, etc.

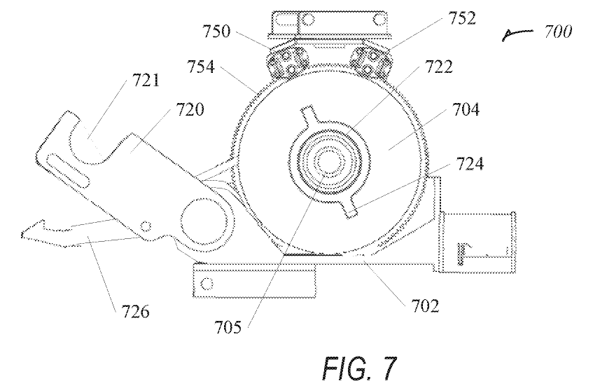

A reaction plate 310 is shown coupled to the device frame 302. The first reaction plate 310 defines a first in-line pipe pulling orientation. A guide pulley 306 is shown adjacent to the winch drum 304, and is illustrated in operation in FIG. 3C. A hinged axle support 320 is shown adjacent a side of the winch drum 304. In FIG. 3A, the hinged axle support is in contact with an a central axle 305, and is movable to permit removal of a removable flange portion of the winch drum 304 as shown in more detail in FIGS. 7-10.

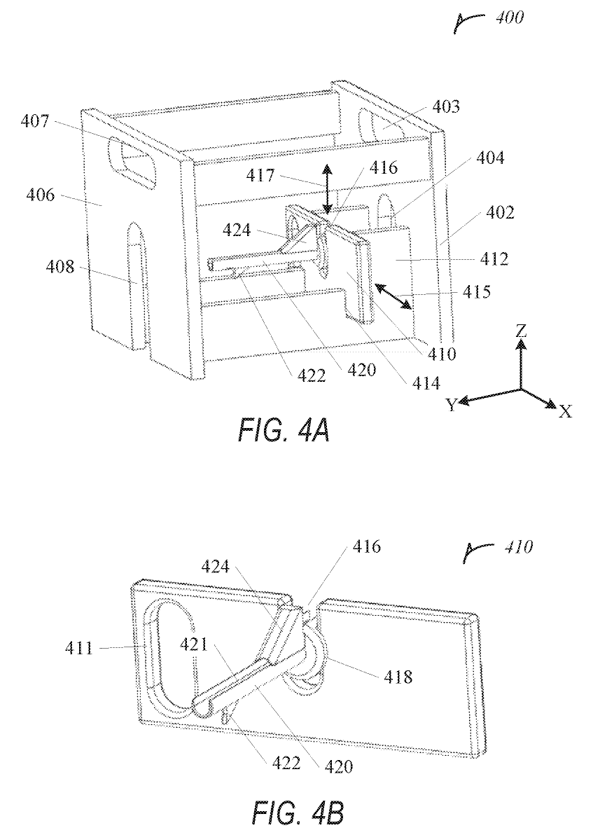

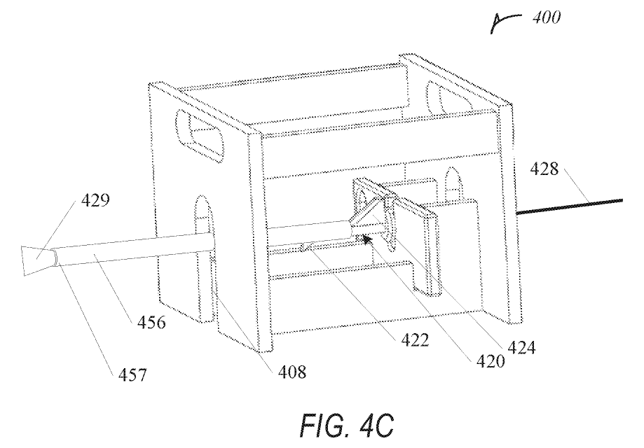

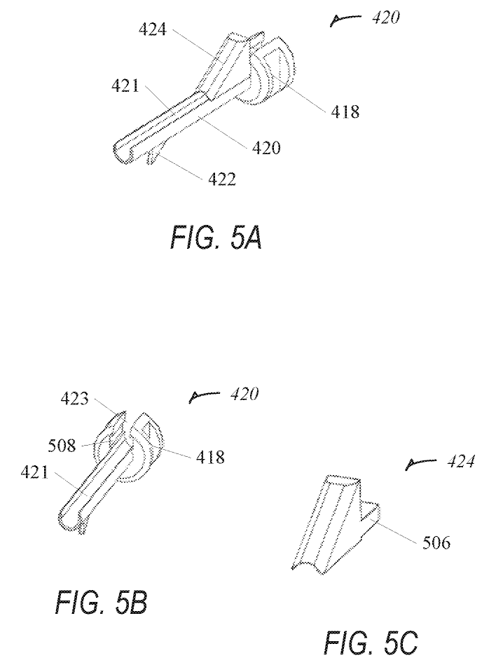

A pipe splitting fixture 330 is shown butted up against the first reaction plate 310. The pipe splitting fixture 330 is discussed in greater detail in FIGS. 4A-4B and 5A-5C. FIG. 3B shows a side opposite to the view of FIG. 4A. In FIG. 4B, fasteners 301 such as bolts, rivets, welds, etc. are shown coupling portions of the device frame 302 together, such as axle support plate 303 and a device mount plate 362. In the view of FIG. 3B, the device frame 302, the axle support plate 303, and the device mount plate 362 are fixed in relation to one another by fasteners 301.

FIG. 3C shows the pipe replacement device 300 in one method of operation. A pit 359 in a ground region 358 is shown, exposing a pipe to be replaced 356. The pipe replacement device 300 is placed with a bottom surface of the device frame 302 in contact with a bottom of the pit 359. The pipe replacement device 300 is configured to align with the pipe to be replaced 356.

The winch drum 304 is coupled to a cable 308. The cable 308 extends over the guide pulley 306 and underneath the device frame 302. The cable 308 then passes through the pipe to be replaced 356 and is coupled to a splitting or bursting tool (not shown) at a distal end of the pipe to be replaced 359. The reaction plate 310 is shown butted up against a side of the pit 359. In the example of FIG. 3C, the pipe splitting fixture 330 is not used as an option, although a configuration as shown in FIG. 3C can also utilize the pipe splitting fixture 330 as an option. In such an option, the pipe splitting fixture 330 can be laterally installed over the cable 308 in between the reaction plate 310 and the side of the pit 359. In the examples shown, the guide pulley 306 is located on the device frame 302 adjacent to the winch drum 304, wherein a tangent of the guide pulley aligns with the pulling orientation shown in FIG. 3C at a first angle, and aligns with the boom 220 from FIGS. 2A and 2B in another pulling orientation at a second angle. With this configuration, a cable can be routed over a common guide pulley in both the first pulling orientation and the second pulling orientation.

In one example, the pipe replacement device 100 shown in FIG. 1 can be converted to the configuration of pipe replacement device 300 shown in FIG. 3C. The boom 120 shown in FIG. 1 is either folded underneath the device frame 102 using the hinge 122, or removed from the device frame 102 by detaching the boom 120 at the hinge 122. When the boom 120 is folded out of the way or removed, the pipe replacement device 100 shown in FIG. 1 is essentially converted to the configuration of the pipe replacement device 300 shown in FIG. 3C. Thus, examples of pipe replacement devices shown are capable of a first in-line pipe pulling orientation (as shown in FIGS. 2A-2B) and a second, optional pulling orientation (as shown in FIG. 3C), different from the first in-line pipe pulling orientation.

FIGS. 4A-4B show an example of components of a pipe splitting fixture 400 similar to the pipe splitting fixtures 130 from FIG. 1, and 330 from FIGS. 3A-3B. The pipe splitting fixture 400 includes a first plate 402 including a first slot 404, and a second plate 406 including a second slot 408. A splitting plate 410 is shown located between the first plate 402 and the second plate 406. A splitter 420 is shown mounted in the splitting plate 410. Carrying handles 403 and 407 are also included in the first and second plates 402, 406. An additional carrying handle 411 is shown included in the splitting plate 410 in FIG. 2B.

In operation as shown in FIG. 4C, a cable 428 is passed through a central open portion of the splitter 420, and through a pipe to be replaced. A distal end of the cable is either fixed (for example with a clamp, or swage or other device) to a distal end 457 of the pipe to be replaced, or a splitting tool 429 may be fixed to the distal end 457 of the pipe to be replaced 456. The cable 428 is then pulled, for example, by rotating a winch drum 304, 204, 104 etc. The pipe to be replaced 456 is completely, or at least partially pulled from the ground, and is pulled into the pipe splitting fixture 400 through the second slot 408. As the pipe is pulled from the ground, it encounters the splitter 420. The pipe to be replaced 456 is then split over the splitter 420 and can be removed from the pit, and disposed of.

The splitter 420 shown in FIGS. 4A-C includes a deflector 424 that encloses the cable 428 within a channel 421 as shown in FIG. 4B. In the example shown, the splitter 420 includes a gut hook shaped blade 422, although the invention is not so limited. In operation, the blade 422 splits the pipe to be replaced 456, and the deflector 424 directs the split pipe upwards within the pipe splitting fixture 400 for removal and disposal.

In one example, the pipe to be replaced 456 is entirely split over the splitter 420 as the pipe to be replaced 456 is removed from the ground. In other examples, a distal end 457 of the pipe to be replaced 456 may be split by a splitting tool 429, and at the same time, a proximal end of the pipe to be replaced 456 is partially removed from the ground and split over the splitter 420.

In order to better align the splitter 420 with the cable and the pipe to be replaced, the splitter 420 of FIGS. 2A and 2B is movable laterally parallel to the first plate 402 and the second plate 406. In one example, the splitter 420 is movable in multiple directions (degrees of freedom) laterally parallel to the first plate 402 and second plate 406. In one example, the splitter 420 is movable along two orthogonal degrees of freedom laterally parallel to the first plate 402 and second plate 406. In one example, the splitter 420 is movable along an X and a Z direction as indicated by the coordinate axes shown in FIG. 4A. A first lateral degree of freedom 417 is accommodated by the splitter 420 being located within a first lateral slot 416 within the splitting plate 410. In the example shown, a second lateral degree of freedom 415 is further provided by the splitting plate 410 being located within splitter plate slots 414 within a splitting plate frame 412. Allowing one or more degrees of freedom 415, 417 facilitates centering of the splitter 420 along an axis determined by the cable and the pipe to be replaced. The first lateral degree of freedom 417 is facilitated as shown in FIG. 4B, by the first lateral slot 416 in the splitting plate 410. A splitter slot 418 on the splitter 420 is shown aligning with the first lateral slot 416 in the splitting plate 410 to provide the first lateral degree of freedom 417 as indicated by arrows in FIG. 4A.

In FIG. 4B, the channel 421 is shown in the splitter 420 to accept a cable, such as cables 308, 208, 108 in examples described above. The deflector 424 is shown enclosing the channel 421. In operation, the deflector 424 is removable, and can be installed over the channel 421 as shown in FIG. 4B after the cable is laterally placed within the channel 421. As noted above, it is advantageous to be able to laterally load components of a splitting system over a cable after the cable is already threaded through a pipe to be replaced. The splitter configuration with the deflector 424 that is removable facilitates this goal. In operation, the pipe splitting fixture 400 can be installed laterally over a cable that is already threaded through a pipe to be replaced using slots 404, 408 in the plates 402, 406 and the deflector 424 that is removable from the channel 421.

FIGS. 5A-5C show detail of various components of the splitter 420 from FIGS. 4A-4C. In FIG. 5A, the splitter 420 is shown with the deflector 424 in place, enclosing the channel 421. The splitter slot 418 is visible without the splitting plate 410 that was included in FIG. 4B. FIG. 5B shows the splitter 420 with the deflector 424 removed. The deflector 424 is shown by itself in FIG. 5C. In FIG. 5B, the channel 421 is exposed, and able to accept a cable laterally through splitter slot 423. A rectangular keyed opening 508 is further shown, adjacent to the splitter slot 423. A deflector key 506 is shown in FIG. 5C. The deflector key 506 is configured to mate with the keyed opening 508 shown in FIG. 5B. After a cable in laterally inserted through the splitter slot 423 and into the channel 421, the deflector key 506 of the deflector 424 can be slid axially into the keyed opening 508, resulting in the configuration shown in FIG. 5A. By using the deflector key 506 and the keyed opening 508, the deflector 424 is rigidly held in place while a pipe to be replaced is pulled over the deflector 424, as shown in FIG. 4C.

The splitting fixture 400 shown can be optionally used with a pipe replacement device as described in examples above to split and remove a pipe to be replaced, while a pulling cable is wrapped around a winch drum as described in examples above. In other example operations a pipe replacement device as described in examples above can be optionally used to wind a cable around a winch drum while the pipe to be replaced remains around the cable. In this operation, the cable and the spooled pipe to be replaced are later removed from the winch drum and may be discarded. An inexpensive cable, such as strand may be used in this type of operation, as the cable will be discarded with the spooled pipe to be replaced. Spooling and removing the pipe to be replaced are discussed in more detail in FIGS. 7-10 below. In other example operations a pipe replacement device as described in examples above can be optionally used with a retaining plate discussed in FIG. 6 below to leave a pipe to be replaced in the ground after splitting.

FIG. 6 shows selected components of a pipe splitting fixture 600 for use with a pipe replacement device on a side of a pit. The components of FIG. 6 are shown to illustrate interchangeability. A reaction plate 690 is shown, similar to the soil stake plate 140 from FIG. 1. The reaction plate 690 includes a vertical slot defined by tabs 692. A splitting fixture 610, similar to the splitting fixture 400, is shown to optionally install in the vertical slot. The splitting fixture 610 includes a first plate 614 with an entry slot 615 and a second plate 616 with an exit slot 617. The entry slot 615 and exit slot 617 help facilitate lateral loading onto a cable, after a cable is already threaded through a pipe to be replaced. The splitting fixture 610 includes a splitter 612 located between the first plate 614 and the second plate 616. In one example, the splitter 612 includes a channel similar to channel 421 for lateral insertion of a cable.

FIG. 6 further shows a retaining plate 620 to optionally install in the vertical slot defined by tabs 692. The retaining plate 620 includes a retaining slot 622 that is dimensioned to allow a cable to pass through the retaining slot 622, but not a pipe to be replaced.

The first plate 614 shown in FIG. 6 includes a dimension 613 to mate with the vertical slot defined by tabs 692. The retaining plate 620 also includes a dimension 621 to mate with the vertical slot defined by tabs 692. In the example shown, the dimension 613 is the same as the dimension 621. Other dimensions, such as thickness of the first plate 614 and the retaining plate 620 may also be similar to better facilitate interchangeability.

In one operation, it is desirable to pull a pipe to be replaced out of the ground for disposal. Examples of such an operation include, but are not limited to, lead pipe removal. In such an example, the splitting fixture 610 may be installed in the vertical slot of the reaction plate 690 defined by tabs 692. As described in other examples above, the pipe to be replaced is allowed to pass through a reaction plate slot 691, and through the entry slot 615 in the first plate 614, where it encounters the splitter 612. The pipe to be replaced is split on the splitter, and can be removed from a pit and disposed of. This is especially desired with lead pipe, due to lead contamination issues.

In another operation, it is desirable for a pipe to be replaced to remain in the ground. A copper or polymer pipe can be left in the ground without contamination issues, and so it may be easier to split the pipe to be replaced and pull in a new pipe while the split pipe to be replaced is pushed aside into the soil. This type of operation is often referred to as pipe bursting. With smaller diameter pipes, however, the pipe to be replaced may begin to partially pull out of the ground, even if pulling out of the ground is not desired. By using the retaining plate 620 instead of the splitting fixture 610 the pipe to be replaced will butt up against the retaining slot 622 while the cable is allowed through the retaining plate 620. In this way, the pipe to be replaced is held in the ground, while a splitter is drawn through the pipe to be replaced. An expander can be used to push the split pipe to be replaced into the surrounding soil while a new pipe is drawn into the space created after splitting the pipe to be replaced.

The ability to interchange the splitting fixture 610 and the retaining plate 620 within the reaction plate 690 provides flexibility for a pipe replacement device such as the pipe replacement device 100 from FIG. 1. Both pipe bursting and pipe removal are possible using one pipe replacement device as described.

FIGS. 7-10 illustrate other features of a pipe replacement device 700 according to selected examples. The pipe replacement device 700 includes a device frame 702. A winch drum 704 is shown coupled to a pair of driving motors 750, 752. Although a pair of motors are shown in the example of FIG. 7, the invention is not so limited. In the example shown, the driving motors 750, 752 engage teeth 754 located on a rim of the winch drum 704. A hinged axle support 720 is shown adjacent a side of the winch drum 704. In FIG. 7, the hinged axle support 720 includes a cutout 721 that is adapted to optionally make contact with an a central axle 705, and is movable to permit removal of a removable flange portion of the winch drum 704 as shown in FIG. 9.

A threaded fastener 722 is shown, to hold the removable flange onto the winch drum 704. In the example of FIG. 7, the threaded fastener 722 includes one or more lateral extensions 724. In the condition shown in FIG. 7, the hinged axle support 720 is rotated back in preparation of removal of the threaded fastener 722. In one example in order to help tighten or loosen the threaded fastener 722, a hammer or other suitable tool may be used to impact one or more of the lateral extensions 724. This facilitates movement of the threaded fastener 722 and makes tightening or removal of the threaded fastener 722 easier. A hinged lock 726 is also shown in FIG. 7. When optionally rotated in place as shown in FIG. 3A, a hinged lock 326 (similar to hinged lock 726 in FIG. 7) can be positioned to engage a lateral extension 724 of the threaded fastener 722. In one example, the hinged lock 326 or 726 can be used to help loosen the threaded fastener 722. In one example, the threaded fastener 722 includes a right-handed thread.

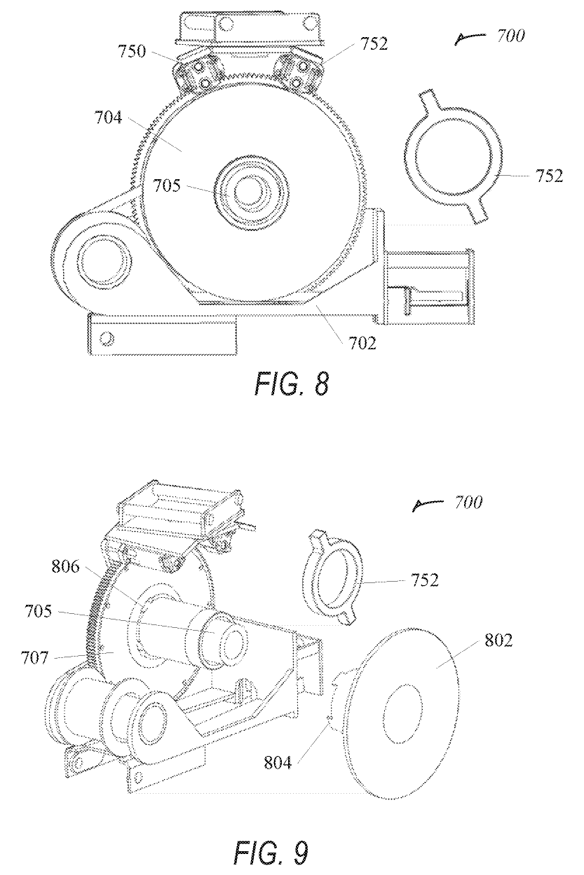

After a pipe removal operation, a pipe to be replaced will be spooled onto the winch drum 704. One method of removing spooled pipe to be replaced, and a cable used to pull the pipe to be replaced, includes first removing the threaded fastener 722. The windings of the pipe to be replaced may cause additional pressure on sides of the drum 705 that make removal of the threaded fastener 722 difficult. When the hinged lock 726 is engaged with the a lateral extension 724 of the threaded fastener 722, and the drum 704 is rotated clockwise, the hinged lock 726 will hold the threaded fastener 722 stationary while the threads on the central axle 705 rotate with the drum 704. If the threaded fastener 722 is thus held, while the central axle 705 threads rotate, the threaded fastener 722 will loosen as the central axle 705 rotates. Once the threaded fastener 722 begins to loosen, the hinged lock 726 can be rotated out of the way as shown in FIG. 7. The threaded fastener 722 can then be unscrewed manually, or with additional impacts from a hammer on the lateral extensions 724 if necessary. This procedure facilitate loosening and removing the threaded fastener 722 as shown in FIG. 8. When not in use, the hinged lock 726 can be held apart from the lateral extension 724 of the threaded fastener 722 as shown in FIG. 3A and FIG. 1.

After removal of the threaded fastener 722, FIG. 9 shows removal of a removable flange 802 opposite a drive side flange 707. The removable flange 802 includes protruding features 804 configured to mate with engaging features 806 that are located on the drive side flange 707. In this way, when the removable flange 802 is in place with the protruding features 804 mating with the engaging features 806, both the drive side flange 707 and the removable flange 802 are driven by the driving motors 750, 752.

When the removable flange 802 is removed, as shown in FIG. 9, any spooled pipe can easily be removed without uncoiling the spooled pipe. This is advantageous, because removed pipe may include a strong cold set shape after pulling and may be difficult to uncoil. Further, the configuration shown in FIG. 7-9 allows the winch drum 704 to be reused for multiple pipe removal operations. A single pipe to be removed will often be longer that will fit on a single winch drum 704, and can more easily be accomplished with multiple pulls.

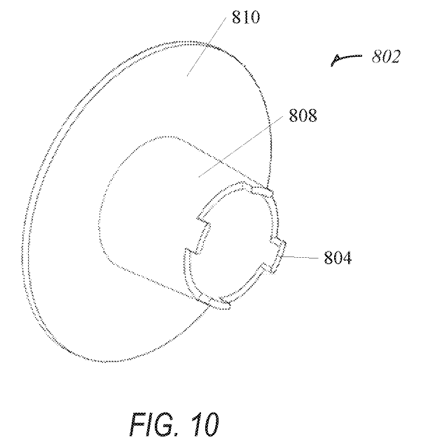

An example of the removable flange 802 is further shown in FIG. 10. An outside flange 810 is shown, and an inner cylinder 808. The protruding features 804 in FIG. 10 include four semi-rectangular features, although the invention is not so limited. Other numbers of features 804 may include one feature or other numbers different than four. Also, the shape of the features 804 may include different geometries. For example, cylinder pins are possible, or squares, or other feature shapes. Additionally, although male features 804 and female engaging features 806 are shown, the sides of the interface can also be reversed, or a mix of some male features on one side and some female features on an opposing side.

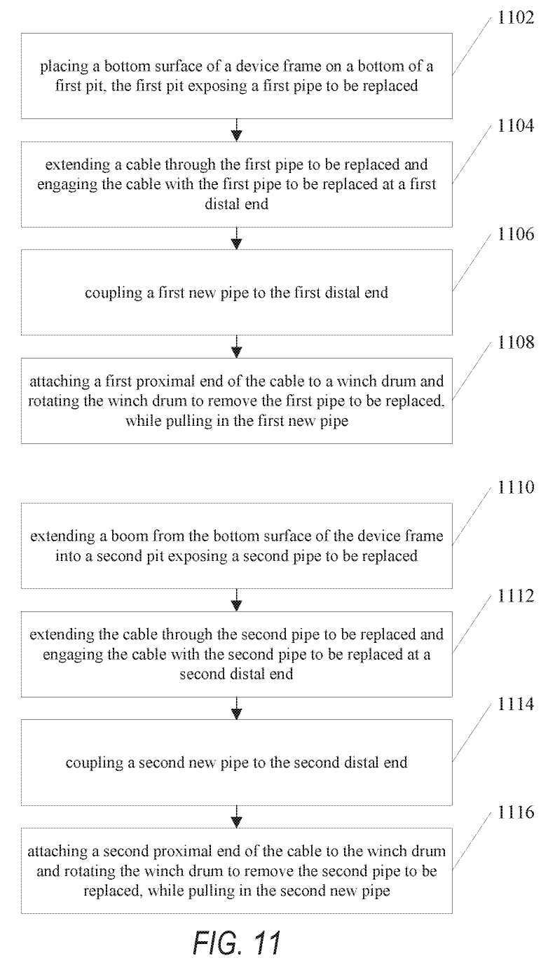

FIG. 11 shows a flow diagram of one example of a method of method of pulling pipe. Operations 1102-1108 describe operations for a first replacement operation. In operation 1102, a bottom surface of a device frame is placed on a bottom of a first pit, the first pit exposing a first pipe to be replaced. In operation 1104, a cable is extended through the first pipe to be replaced and the cable is engaged with the first pipe to be replaced at a first distal end. In operation 1106, a first new pipe is coupled to the first distal end. In operation 1108, a first proximal end of the cable is attached to a winch drum and the winch drum is rotated to remove the first pipe to be replaced, while pulling in the first new pipe.

Operations 1110-1116 describe operations for a second replacement operation. In operation 1110, a boom is extended from the bottom surface of the device frame into a second pit exposing a second pipe to be replaced. In operation 1112, the cable is extended through the second pipe to be replaced and the cable is engaged with the second pipe to be replaced at a second distal end In operation 1114, a second new pipe is coupled to the second distal end. In operation 1116, a second proximal end of the cable is attached to the winch drum and the winch drum is rotated to remove the second pipe to be replaced, while pulling in the second new pipe.

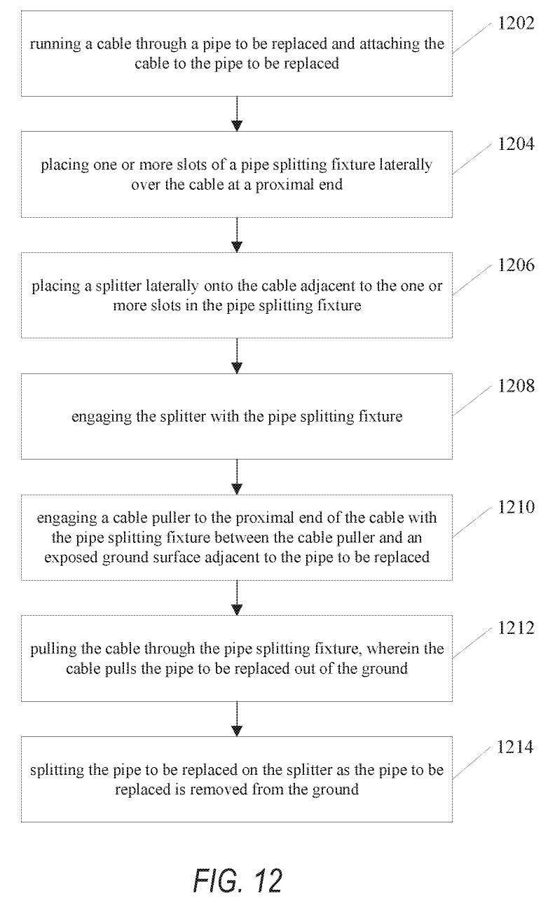

FIG. 12 shows a flow diagram of another example of a method of method of pulling pipe. In operation 1202, a cable is run through a pipe to be replaced and the cable is attached to the pipe to be replaced. In operation 1204, one or more slots of a pipe splitting fixture are placed laterally over the cable at a proximal end. In operation 1206, a splitter is placed laterally onto the cable adjacent to the one or more slots in the pipe splitting fixture. In operation 1208, the splitter is engaged with the pipe splitting fixture. In operation 1210, a cable puller is engaged to the proximal end of the cable with the pipe splitting fixture between the cable puller and an exposed ground surface adjacent to the pipe to be replaced. In operation 1212, the cable is pulled through the pipe splitting fixture, and the cable pulls the pipe to be replaced out of the ground. In operation 1214, the pipe to be replaced is split on the splitter as the pipe to be replaced is removed from the ground.

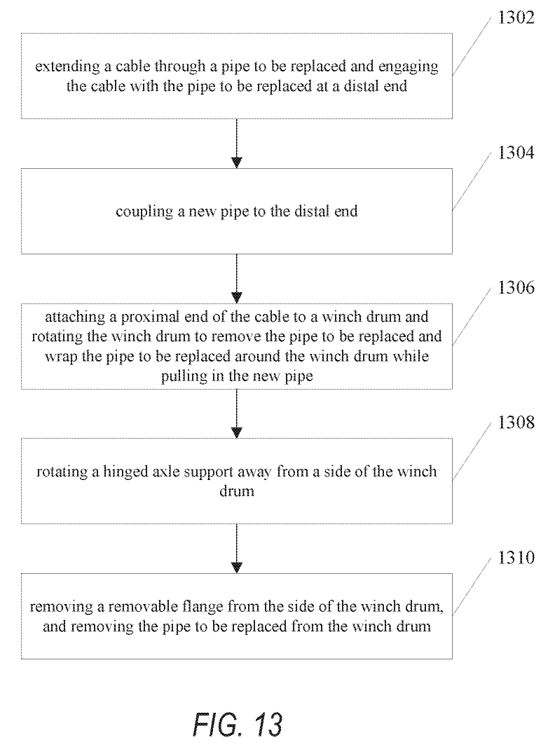

FIG. 13 shows a flow diagram of another example of a method of method of pulling pipe. In operation 1302, a cable is extended through a pipe to be replaced and the cable is engaged with the pipe to be replaced at a distal end. In operation 1304, a new pipe is coupled to the distal end. In operation 1306, a proximal end of the cable is attached to a winch drum and the winch drum is rotated to remove the pipe to be replaced and wrap the pipe to be replaced around the winch drum while pulling in the new pipe. In operation 1308, a hinged axle support is rotated away from a side of the winch drum. In operation 1310, a removable flange is removed from the side of the winch drum, and the pipe to be replaced is removed from the winch drum.

To better illustrate the method and apparatuses disclosed herein, a non-limiting list of embodiments is provided here:

Aspect 1. A pipe replacement device, comprising: a device frame; a winch drum coupled to a driving motor, the winch drum rotatably mounted to the device frame; a first reaction plate coupled to the device frame, defining a first in-line pipe pulling orientation; a boom coupled to the device frame, the boom defining a second, optional pulling orientation, different from the first in-line pipe pulling orientation.

Aspect 2. The pipe replacement device of aspect 1, wherein the driving motor includes multiple hydraulic driving motors.

Aspect 3. The pipe replacement device of aspect 1, further including a mount adapted to attach to an arm of a ground working vehicle.

Aspect 4. The pipe replacement device of aspect 3, wherein the ground working vehicle includes a backhoe.

Aspect 5. The pipe replacement device of aspect 1, wherein the boom in configured to fold beneath the device frame when not in use.

Aspect 6. The pipe replacement device of aspect 1, wherein the boom further includes a pulley at a distal end, and a second reaction plate adjacent to the pulley, wherein the second reaction plate is arced.

Aspect 7. The pipe replacement device of aspect 1, further including a guide pulley adjacent to the winch drum, wherein a tangent of the guide pulley aligns with the first in-line pipe pulling orientation at a first angle, and aligns with the boom at a second angle.

Aspect 8. The pipe replacement device of aspect 1, wherein the boom rotates with respect to a bottom surface of the device frame.

Aspect 9. A method of pulling pipe, comprising: in a first replacement operation; placing a bottom surface of a device frame on a bottom of a first pit, the first pit exposing a first pipe to be replaced; extending a cable through the first pipe to be replaced and engaging the cable with the first pipe to be replaced at a first distal end; coupling a first new pipe to the first distal end; attaching a first proximal end of the cable to a winch drum and rotating the winch drum to remove the first pipe to be replaced, while pulling in the first new pipe; in a second replacement operation; extending a boom from the bottom surface of the device frame into a second pit exposing a second pipe to be replaced; extending the cable through the second pipe to be replaced and engaging the cable with the second pipe to be replaced at a second distal end; coupling a second new pipe to the second distal end; attaching a second proximal end of the cable to the winch drum and rotating the winch drum to remove the second pipe to be replaced, while pulling in the second new pipe.

Aspect 10. The method of aspect 9, further including selecting an angle of the boom with respect to the bottom surface of the device frame to select a boom depth.

Aspect 11. The method of aspect 10, further including abutting an arced reaction plate against a lateral surface within the second pit at the selected angle.

Aspect 12. The method of aspect 9, further including routing the cable over a common guide pulley in both the first replacement operation and the second replacement operation.

Aspect 13. The method of aspect 9, wherein rotating the winch drum to remove the first pipe to be replaced includes wrapping the first pipe to be replaced around the winch drum along with the cable.

Aspect 14. The method of aspect 9, wherein rotating the winch drum to remove the first pipe to be replaced includes splitting the first pipe to be replaced and removing the first pipe to be replaced from the cable before winding the cable around the winch drum.

Aspect 15. The method of aspect 9, wherein rotating the winch drum to remove the second pipe to be replaced includes wrapping the second pipe to be replaced around the winch drum along with the cable.

Aspect 16. The method of aspect 14, wherein rotating the winch drum to remove the second pipe to be replaced includes splitting the second pipe to be replaced and removing the second pipe to be replaced from the cable before winding the cable around the winch drum.

Aspect 17. The method of aspect 9, wherein splitting the first pipe to be replaced and splitting the second pipe to be replaced includes utilizing a single splitting fixture in line with the bottom surface of the device frame in the first replacement operation, and at a distal end of the boom in the second replacement operation.

Aspect 18. A pipe splitting fixture, comprising: a first plate, including an entry slot; a second plate, including an exit slot; a splitting plate mounted between the first plate and the second plate; and a splitter mounted in the splitting plate, wherein the splitter includes a slot for lateral insertion of a cable.

Aspect 19. The pipe splitting fixture of aspect 18, wherein the splitter includes a gut hook blade.

Aspect 20. The pipe splitting fixture of aspect 18, wherein the splitter includes a deflector that encloses the cable when installed on the splitter.

Aspect 21. The pipe splitting fixture of aspect 18, wherein the splitter is movable laterally parallel to the first plate and the second plate.

Aspect 22. The pipe splitting fixture of aspect 21, wherein the splitter is movable in a first direction within a first slot in the splitting plate.

Aspect 23. The pipe splitting fixture of aspect 22, wherein the splitting plate is movable in a second direction within a second slot between the first plate and the second plate.

Aspect 24. The pipe splitting fixture of aspect 18, further including one or more carrying handles formed within one or more plates of the pipe splitting fixture.

Aspect 25. A method of splitting a pipe, comprising; running a cable through a pipe to be replaced and attaching the cable to the pipe to be replaced; placing one or more slots of a pipe splitting fixture laterally over the cable at a proximal end; placing a splitter laterally onto the cable adjacent to the one or more slots in the pipe splitting fixture; engaging the splitter with the pipe splitting fixture; engaging a cable puller to the proximal end of the cable with the pipe splitting fixture between the cable puller and an exposed ground surface adjacent to the pipe to be replaced; pulling the cable through the pipe splitting fixture, wherein the cable pulls the pipe to be replaced out of the ground; and splitting the pipe to be replaced on the splitter as the pipe to be replaced is removed from the ground.

Aspect 26. The method of aspect 25, further including adjusting a lateral location of the splitter within the pipe splitting fixture to align with the cable between the exposed ground surface and the cable puller.

Aspect 27. The method of aspect 26, wherein adjusting the lateral location of the splitter within the pipe splitting fixture includes adjusting in both an X and Z axis plane.

Aspect 28. The method of aspect 25, wherein placing a splitter laterally onto the cable includes enclosing the cable in the splitter by attaching a deflector over a lateral splitter slot.

Aspect 29. A pipe splitting fixture, comprising: a reaction plate, including a vertical slot; a splitting fixture to optionally install in the vertical slot, the splitting fixture including; a first plate, including an entry slot; a second plate, including an exit slot; a splitting plate mounted between the first plate and the second plate; and a splitter mounted in the splitting plate, wherein the splitter includes a slot for lateral insertion of a cable, and; a retaining plate to optionally install in the vertical slot, the retaining plate including a retaining slot that is dimensioned to allow a cable to pass through the retaining slot, but not a pipe to be replaced.

Aspect 30. The pipe splitting fixture of aspect 29, wherein the splitter includes a gut hook blade.

Aspect 31. The pipe splitting fixture of aspect 30, wherein the splitter includes a deflector that encloses the cable when installed on the splitter.

Aspect 32. A pipe replacement device, comprising: a device frame; a winch drum coupled to a driving motor, the winch drum rotatably mounted to the device frame, wherein the winch drum includes; a drive side flange that is driven by the driving motor; a removable flange opposite the drive side flange to allow removal of a pipe to be replaced after removing the pipe to be replaced from the ground and winding around the winch drum; and a hinged axle support adjacent to the removable flange, wherein the hinged axle support is movable to permit removal of the removable flange.

Aspect 33. The pipe replacement device of aspect 32, further including a threaded fastener to hold the removable flange onto the winch drum, the threaded fastener including one or more lateral extensions.

Aspect 34. The pipe replacement device of aspect 33, further including a hinged lock that optionally engages the one or more lateral extensions.

Aspect 35. The pipe replacement device of aspect 32, wherein the removable flange is coupled to a central drum portion, and wherein the central drum portion includes one or more engaging features that mate with one or more mating features on the drive side flange.

Aspect 36. A method of pulling pipe, comprising: extending a cable through a pipe to be replaced and engaging the cable with the pipe to be replaced at a distal end; coupling a new pipe to the distal end; attaching a proximal end of the cable to a winch drum and rotating the winch drum to remove the pipe to be replaced and wrap the pipe to be replaced around the winch drum while pulling in the new pipe; rotating a hinged axle support away from a side of the winch drum; removing a removable flange from the side of the winch drum, and removing the pipe to be replaced from the winch drum.

Aspect 37. The method of aspect 36, further including unthreading a threaded fastener to release the removable flange from the winch drum.

Aspect 38. The method of aspect 37, wherein removing the threaded fastener includes impacting one or more lateral extensions that extend from the threaded fastener to release thread tension.

Aspect 39. The method of aspect 38, further including rotating a hinged lock to engage the one or more lateral extensions hold the threaded fastener while rotating the winch drum to loosen the threaded fastener.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A pipe replacement device, comprising:
a device frame;
a winch drum coupled to a driving motor, the winch drum rotatably mounted to the device frame;
a first reaction plate coupled to the device frame, defining a first in-line pipe pulling orientation;
a boom coupled to the device frame, the boom defining a second, optional pulling orientation, different from the first in-line pipe pulling orientation.

2. The pipe replacement device of claim 1, wherein the driving motor includes multiple hydraulic driving motors.

3. The pipe replacement device of claim 1, further including a mount adapted to attach to an arm of a ground working vehicle.

4. The pipe replacement device of claim 3, wherein the ground working vehicle includes a backhoe.

5. The pipe replacement device of claim 1, wherein the boom in configured to fold beneath the device frame when not in use.

6. The pipe replacement device of claim 1, wherein the boom further includes a pulley at a distal end, and a second reaction plate adjacent to the pulley, wherein the second reaction plate is arced.

7. The pipe replacement device of claim 1, further including a guide pulley adjacent to the winch drum, wherein a tangent of the guide pulley aligns with the first in-line pipe pulling orientation at a first angle, and aligns with the boom at a second angle.

8. The pipe replacement device of claim 1, wherein the boom rotates with respect to a bottom surface of the device frame.

9. A method of pulling pipe, comprising:
in a first replacement operation;
placing a bottom surface of a device frame on a bottom of a first pit, the first pit exposing a first pipe to be replaced;
extending a cable through the first pipe to be replaced and engaging the cable with the first pipe to be replaced at a first distal end;
coupling a first new pipe to the first distal end;
attaching a first proximal end of the cable to a winch drum and rotating the winch drum to remove the first pipe to be replaced, while pulling in the first new pipe;
in a second replacement operation;
extending a boom from the bottom surface of the device frame into a second pit exposing a second pipe to be replaced;
extending the cable through the second pipe to be replaced and engaging the cable with the second pipe to be replaced at a second distal end;
coupling a second new pipe to the second distal end;
attaching a second proximal end of the cable to the winch drum and rotating the winch drum to remove the second pipe to be replaced, while pulling in the second new pipe.

10. The method of claim 9, further including selecting an angle of the boom with respect to the bottom surface of the device frame to select a boom depth.

11. The method of claim 10, further including abutting an arced reaction plate against a lateral surface within the second pit at the selected angle.

12. The method of claim 9, further including routing the cable over a common guide pulley in both the first replacement operation and the second replacement operation.

13. The method of claim 9, wherein rotating the winch drum to remove the first pipe to be replaced includes wrapping the first pipe to be replaced around the winch drum along with the cable.

14. The method of claim 9, wherein rotating the winch drum to remove the first pipe to be replaced includes splitting the first pipe to be replaced and removing the first pipe to be replaced from the cable before winding the cable around the winch drum.

15. The method of claim 9, wherein rotating the winch drum to remove the second pipe to be replaced includes wrapping the second pipe to be replaced around the winch drum along with the cable.

16. The method of claim 14, wherein rotating the winch drum to remove the second pipe to be replaced includes splitting the second pipe to be replaced and removing the second pipe to be replaced from the cable before winding the cable around the winch drum.

17. The method of claim 9, wherein splitting the first pipe to be replaced and splitting the second pipe to be replaced includes utilizing a single splitting fixture in line with the bottom surface of the device frame in the first replacement operation, and at a distal end of the boom in the second replacement operation.

18. A pipe splitting fixture, comprising:
a first plate, including an entry slot;
a second plate, including an exit slot;
a splitting plate mounted between the first plate and the second plate; and
a splitter mounted in the splitting plate, wherein the splitter includes a slot for lateral insertion of a cable.

19. The pipe splitting fixture of claim 18, wherein the splitter includes a gut hook blade.

20. The pipe splitting fixture of claim 18, wherein the splitter includes a deflector that encloses the cable when installed on the splitter.

21. The pipe splitting fixture of claim 18, wherein the splitter is movable laterally parallel to the first plate and the second plate.

22. The pipe splitting fixture of claim 21, wherein the splitter is movable in a first direction within a first slot in the splitting plate.

23. The pipe splitting fixture of claim 22, wherein the splitting plate is movable in a second direction within a second slot between the first plate and the second plate.

24. The pipe splitting fixture of claim 18, further including one or more carrying handles formed within one or more plates of the pipe splitting fixture.

25. A method of splitting a pipe, comprising;
running a cable through a pipe to be replaced and attaching the cable to the pipe to be replaced;
placing one or more slots of a pipe splitting fixture laterally over the cable at a proximal end;
placing a splitter laterally onto the cable adjacent to the one or more slots in the pipe splitting fixture;
engaging the splitter with the pipe splitting fixture;
engaging a cable puller to the proximal end of the cable with the pipe splitting fixture between the cable puller and an exposed ground surface adjacent to the pipe to be replaced;
pulling the cable through the pipe splitting fixture, wherein the cable pulls the pipe to be replaced out of the ground; and
splitting the pipe to be replaced on the splitter as the pipe to be replaced is removed from the ground.

26. The method of claim 25, further including adjusting a lateral location of the splitter within the pipe splitting fixture to align with the cable between the exposed ground surface and the cable puller.

27. The method of claim 26, wherein adjusting the lateral location of the splitter within the pipe splitting fixture includes adjusting in both an X and Z axis plane.

28. The method of claim 25, wherein placing a splitter laterally onto the cable includes enclosing the cable in the splitter by attaching a deflector over a lateral splitter slot.

29. A pipe splitting fixture, comprising:
a reaction plate, including a vertical slot;
a splitting fixture to optionally install in the vertical slot, the splitting fixture including;
a first plate, including an entry slot;
a second plate, including an exit slot;
a splitting plate mounted between the first plate and the second plate; and
a splitter mounted in the splitting plate, wherein the splitter includes a slot for lateral insertion of a cable, and;
a retaining plate to optionally install in the vertical slot, the retaining plate including a retaining slot that is dimensioned to allow a cable to pass through the retaining slot, but not a pipe to be replaced.

30. The pipe splitting fixture of claim 29, wherein the splitter includes a gut hook blade.

31. The pipe splitting fixture of claim 30, wherein the splitter includes a deflector that encloses the cable when installed on the splitter.

32. A pipe replacement device, comprising:
a device frame;
a winch drum coupled to a driving motor, the winch drum rotatably mounted to the device frame, wherein the winch drum includes;
a drive side flange that is driven by the driving motor;
a removable flange opposite the drive side flange to allow removal of a pipe to be replaced after removing the pipe to be replaced from the ground and winding around the winch drum; and
a hinged axle support adjacent to the removable flange, wherein the hinged axle support is movable to permit removal of the removable flange.

33. The pipe replacement device of claim 32, further including a threaded fastener to hold the removable flange onto the winch drum, the threaded fastener including one or more lateral extensions.

34. The pipe replacement device of claim 33, further including a hinged lock that optionally engages the one or more lateral extensions.

35. The pipe replacement device of claim 32, wherein the removable flange is coupled to a central drum portion, and wherein the central drum portion includes one or more engaging features that mate with one or more mating features on the drive side flange.

36. A method of pulling pipe, comprising:
extending a cable through a pipe to be replaced and engaging the cable with the pipe to be replaced at a distal end;
coupling a new pipe to the distal end;
attaching a proximal end of the cable to a winch drum and rotating the winch drum to remove the pipe to be replaced and wrap the pipe to be replaced around the winch drum while pulling in the new pipe;
rotating a hinged axle support away from a side of the winch drum;
removing a removable flange from the side of the winch drum, and removing the pipe to be replaced from the winch drum.

37. The method of claim 36, further including unthreading a threaded fastener to release the removable flange from the winch drum.

38. The method of claim 37, wherein removing the threaded fastener includes impacting one or more lateral extensions that extend from the threaded fastener to release thread tension.

39. The method of claim 38, further including rotating a hinged lock to engage the one or more lateral extensions hold the threaded fastener while rotating the winch drum to loosen the threaded fastener.
